(19) United States
(12) Patent Application Publication
(10) Pub. No.: US 2013/0293375 A1
(43) Pub. Date: Nov. 7, 2013

(54) WIRELESS ALARM SYSTEM

(71) Applicant: Horst Dreier, (US)

(72) Inventor: Horst Dreier, Horb am Neckar (DE)

(21) Appl. No.: 13/935,162

(22) Filed: Jul. 3, 2013

Related U.S. Application Data
(63) Continuation-in-part of application No. 13/833,586, filed on Mar. 15, 2013.
(60) Provisional application No. 61/667,441, filed on Jul. 3, 2012.

(30) Foreign Application Priority Data
May 3, 2012 (DE) 20 2012 004 844.9

(51) Int. Cl. G08B 1/08

(52) U.S. Cl. CPC G08B 1/08
USPC 340/539.1

(57) ABSTRACT

A wireless alarm system has at least one radio controllable alarm unit for identifying and indicating a danger and at least one radio remote control device for releasing an alarm. The radio controllable alarm unit is arranged stationary in a freely selectable position inside a building and/or a community and/or a street and/or a landscape.

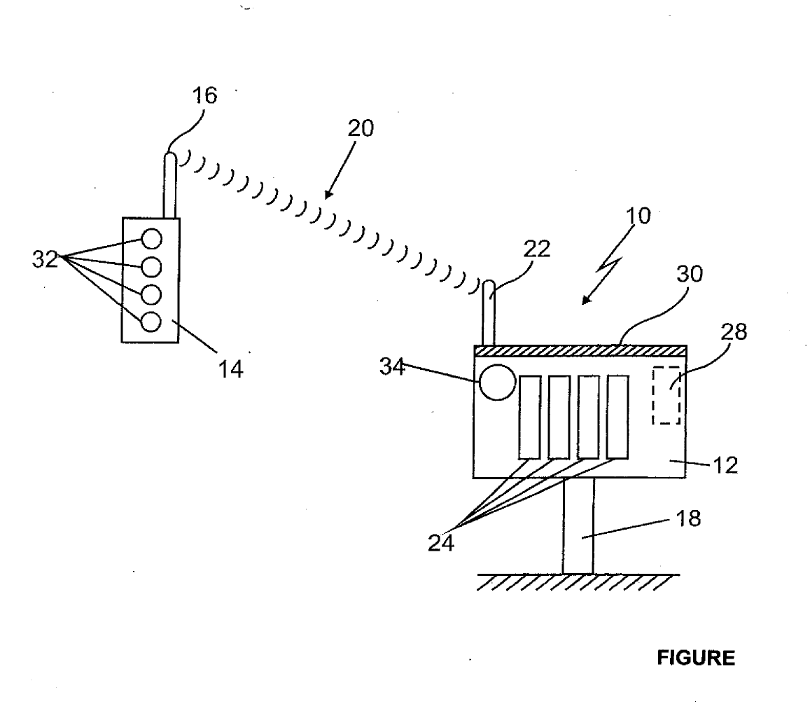

### CROSS-REFERENCES TO RELATED APPLICATIONS

This application is a continuation-in-part of prior filed copending U.S. application No. 13/833,586, filed Mar. 15, 2013, the priority of which is hereby claimed under 35 U.S.C. §120 and which claims the benefit of prior filed U.S. provisional Application No. 61/641,935, filed May 3, 2012, pursuant to 35 U.S.C. 119(e) and claims the priority of German Patent Application, Serial No. 20 2012 004 844.9, filed May 3, 2012, pursuant to 35 U.S.C. 119(a)-(d).

This application further claims the benefit of prior filed U.S. provisional Application No. 61/667,441, filed Jul. 3, 2012, pursuant to 35 U.S.C. 119(e).

The contents of U.S. application No. 13/833,586, U.S. provisional Application No. 61/641,935, and U.S. provisional Application No. 61/667,441 are incorporated herein by reference in their entirety as if fully set forth herein.

### BACKGROUND OF THE INVENTION

The present invention relates to a wireless alarm system.

The following discussion of related art is provided to assist the reader in understanding the advantages of the invention, and is not to be construed as an admission that this related art is prior art to this invention.

Wireless alarm systems typically include at least one radio remote control device and at least one alarm unit. A wireless signal is sent by the radio remote control device by operating a keyboard, and has an electronic address of the at least one alarm unit. The wireless signal received by the alarm unit is evaluated and an alarm signal is triggered, for example an acoustic reaction (for example a signal tone) and/or an optical reaction (for example a blinking light). Such alarm units are known as so-called pagers, buzzers, beepers or signal devices and typically involve small radio receivers that are carried by people for a wireless service and used for producing alarms and transmitting information. Such wireless alarm systems are used by authorities and organizations for security purposes, for example as alarm system of the fire department to inform their members about an impending emergency.

It would be desirable and advantageous to provide an improved wireless alarm system which obviates prior art shortcomings and is directed to an extended, at least partially unknown circle of people, whereby the people concerned do not carry any alarm unit.

### SUMMARY OF THE INVENTION

According to one aspect of the present invention, a wireless alarm system includes at least one radio controllable alarm unit for identifying and indicating a danger, the at least one wireless controllable alarm unit being arranged stationary in a freely selectable position inside an object selected from the group consisting of inside a building, outside a building, a community, a street, a landscape, and combinations thereof, and at least one radio remote control device for triggering an alarm in response to an identification of a danger by the radio controllable alarm unit.

In accordance with the present invention, the alarm unit is placed in a location that can be seen by many concerned people, and the people suitably interpret the alarm signal that is output by the alarm unit. The alarm unit can be provided for example in schools, kindergartens, hospitals or other public facilities and/or inside the respective buildings, for example in corridors, and provide warning before an assault, a fire, an accident or any other danger. The alarm signal can be triggered directly by any person who has a radio remote control device of the wireless alarm system. The identification and the indication of a danger on the alarm unit is provided on the alarm unit instantly and without delay as opposed to conventional alarm systems which normally have to report a danger first to a central location which, in turn, then informs other concerned persons.

A wireless alarm system may also be installed in particular on the inner side of windows in banks, gas stations or shops e.g. for warning in the event of an accident.

The alarm unit can be placed for example on a highway to warn a driver, for example of a traffic jam or of a motor vehicle driving the wrong way.

The alarm unit can also serve for example as a sign post for a recommended direction to a certain target location in a building, a forest, to a monument or a large area object (park, company grounds, large-scale farms, museum, etc.).

The alarm unit can be also arranged for superordinate traffic regulation additionally onto a traffic light system, for example for clearing an intersection for police cars, fire engines and/or hospital emergency vehicles.

When large-scale farms are involved, for example for farms in the USA, the alarm unit can be arranged for example on mailboxes (also on so-called safety mailboxes), that are typically positioned on busy roads. It is possible to signal to passing traffic about a danger or threat in connection with the farm. The road can be distanced from a building structure far enough so that a possible threat or accident in a remote building structure may remain unnoticed.

According to another advantageous feature of the present invention, the alarm unit can be configured to produce an alarm of optical and/or acoustic nature. Differently formed light sources can be arranged for example in the alarm unit, and can operate as warning signals. As an alternative or in addition, a loudspeaker can be arranged to generate an acoustic warning signal.

According to another advantageous feature of the present invention, the alarm unit can have solar cells, and the alarm unit can be operated by current generated by the solar cells. Advantageously, the alarm unit can have at least one accumulator for storing the electric current generated by the solar cells. This guarantees a continuous power supply of the alarm unit, without the need to exchange batteries. The alarm unit is thus operational at any time. As an alternative, the alarm unit may also be supplied with electric energy by a power connection and a transformer.

According to another advantageous feature of the present invention, the alarm unit can have a plurality of light sources which emit lights of different colors and are controllable by the radio remote control device individually or in groups. The light source can be a light diode or a group of light diodes because of their low current consumption. Their light action can be enhanced by optically operating elements, for example reflectors or light conductors. The light sources that radiate in color enhance the attention of persons passing by the alarm unit.

The different light colors of the light sources and/or a combination of several light sources can identify different stages of danger. The simplest interpretation of the lights of light sources on the alarm unit can be an interpretation in accordance with the known meaning of the traffic light colors. On the other hand, there is also a possibility, in particular in an enclosed environment, for example a school, to define the interpretation of color of light sources in any desired way and for particular purposes. For example, in a school, it is possible to signal a break by a white light of a light source, to signal a written test in a hall by a yellow light of a light source, to signal an accident or another danger by a red light of a light source, and to provide a red light of a light source together or in alternating blinking mode with a blue light of a light source in the event of a highest danger, for example a person running amok.

According to another advantageous feature of the present invention, the light sources can be controllable by the radio remote control device so as to blink and/or provide light in a horizontal direction and/or in a vertical direction. The blinking can, for example, identify a special urgency.

According to another advantageous feature of the present invention, the light sources of the alarm unit can provide light in a horizontal direction. However, in a special case, in particular when the alarm unit is arranged outside of buildings, it is possible to arrange the light sources to emit light also in a vertical direction so that the warning signal becomes visible also from an airplane or a helicopter.

According to another advantageous feature of the present invention, the alarm unit can be configured to illuminate a readable text. The readable texts can be pre-installed in the alarm unit and can be illuminated on the alarm unit by light of the light sources in response to a corresponding command by the radio remote control device.

According to another advantageous feature of the present invention, the radio remote control device can be carried on the human body and the alarm can be triggered substantially inconspicuously by a single, targeted actuation. Such a configuration of the wireless alarm system is useful e.g. when installed in commercial banks, saving banks, shops, especially jewelry stores, or also in gas stations. In the event of a possible holdup, the alarm can be triggered inconspicuously, causing, e.g. via a display panel on a window or at a location that is much frequented by passing people, a display of a message indicating a danger situation or call for help. The display panel should hereby be positioned in such a way as to be invisible from inside the building, e.g. on the inner side of a window.

According to another advantageous feature of the present invention, the wireless alarm system can be a proprietary system that can transmit coded signals between the radio remote control device and the alarm unit. The wireless alarm system thus represents an autarkic system that does not allow unauthorized persons to trigger false alarms in the alarm unit. To further increase the security of the alarm system, it is possible that the alarm unit can send back to the radio remote control device a verification message via a correctly received and thus correctly interpretable signal.

### BRIEF DESCRIPTION OF THE DRAWING

Other features and advantages of the present invention will be more readily apparent upon reading the following description of currently preferred exemplified embodiments of the invention with reference to the accompanying drawing, in which the sole FIGURE shows a wireless alarm system in accordance with the present invention.

### DETAILED DESCRIPTION OF PREFERRED EMBODIMENTS

The depicted embodiment is to be understood as illustrative of the invention and not as limiting in any way. It should also be understood that the figure is not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the Figure, there is shown a wireless alarm system in accordance with the present invention, generally designated by reference numeral 10 and having at least one radio controllable alarm unit 12 for identification and indication of a danger, and at least one radio remote control device 14 for releasing an alarm. The alarm unit 12 can be arranged stationary in a freely selectable position inside and/or outside a building, a community, a street and/or a landscape. In the non-limiting example of the wireless alarm system in the Figure, the alarm unit 12 is arranged on a free standing mast 18 that is firmly inserted into the ground. Of course, the alarm unit may also be arranged for example on a building wall or on a traffic light system

The radio remote control device 14 has an antenna 16 that can provide a wireless connection 20 with the alarm unit 12. The alarm unit 12 also has an antenna 22 for this purpose.

Furthermore, the alarm unit 12 shown in the Figure has several light sources 24 which emit lights of different colors. For example, a first light 24 can emit white light, a second light 24 can emit yellow light, a third light 24 can emit red light, and a fourth light 24 can emit blue light. The number and the associated colors of the light sources 24 can be selectable arbitrarily and can be adapted to the application at hand. The different colors of the lights emitted by the light sources 24 serve for indication of a danger, an accident or any other situation that is in need for help. Each color of a light source 24 or combinations of different colors identify a predetermined danger stage or a predetermined indication. A particular urgency can be made clear by blinking of the light source 24. In the case of a traffic light system, the green and/or red light of the traffic light system can be emphasized by a blinking of the light sources 24 of the alarm unit 12 with the same color to indicate that passage is permitted or passage is barred. A particular danger can be identified for example by alternating blinking of a red light source and a green light source 24 of the alarm unit 12.

The light sources 24 emit light in a horizontal direction. However when needed, the light sources 24 can be configured to emit light vertically so that corresponding signals are visible from the air, for example from a helicopter. The light sources 24 can be controllable individually or in groups by the radio remote control device 14 via the wireless communication 20. To provide small energy consumption, the light sources 24 can be formed as light diodes or a group of light diodes. Their light action can be amplified by optically active elements, such as for example reflectors or light conductors.

It is also possible that a readable warning or indicating text can be illuminated, or the group of several light diodes provides indication of a text. The respective texts can be pre-installed in the alarm unit 12 and can be optically highlighted by the light of the light sources 24 in case of respective commands by the radio remote control device 14 on the alarm unit 12.

Alternatively or additionally, the alarm unit 12 can output also acoustic signals by a loudspeaker 34 that can be arranged in the alarm unit 12. The loudspeaker 34 can also be controlled by the radio remote control device 14. Siren tones, bell tones or also spoken words that are stored in the alarm unit 12 can be used as the acoustic signal.

In order to make sure that the alarm unit 12 is operational at any time, the alarm unit 12 is provided with an accumulator 28 that supplies electrical energy to the light sources 24. The accumulator 28 stores electrical energy which is generated by the solar cells 30 arranged on the alarm unit 12.

The radio remote control device 14 is provided with operating buttons 32, formed for example, as a keyboard for controlling the alarm unit 12. In the simplest case a certain light source 24 of the alarm unit 12 can be controlled by the operating buttons 32. For example, by maintaining pressure on an operating button 32 for an extended period, the light source 24 can be caused to blink. It is also possible that by acting on the operating buttons 32 of the radio remote control device 14, a function in an operating menu can be selected to produce a desired reaction of the light source 24 or the light sources 24 and/or the loudspeaker on the alarm unit 12.

The radio remote control device 14 has a control unit that stores the information as to which light source 24 or light sources 24 and/or which acoustic signal can emit light, can blink or can be audible in response to the corresponding selection. It is accessed and transmitted to the alarm unit 12 via the wireless communication 20 by actuation of an operating button.

The wireless alarm system 10 can also be formed as a proprietary system that transmits coded signals between the radio remote control device 14 and the alarm unit 12. The wireless alarm system 10 therefore can be an autarkic system that does not allow unauthorized persons to trigger false alarms on the alarm unit 12. For increasing the safety of the wireless alarm system 10, it is possible to design it so that the alarm unit 12 can send a verification message back to the radio remote control device 14 over a correctly received and thereby correctly interpretable signal.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A wireless alarm system, comprising:
at least one radio controllable alarm unit for identifying and indicating a danger, said at least one wireless controllable alarm unit being arranged stationary in a freely selectable position inside an object selected from the group consisting of inside a building, outside a building, a community, a street, a landscape, and combinations thereof; and
at least one radio remote control device for triggering an alarm in response to an identification of a danger by the radio controllable alarm unit.

2. The wireless alarm system of claim 1, wherein the alarm unit is configured to produce an alarm selected from the group consisting of an optical alarm, an acoustic alarm, and both.

3. The wireless alarm system of claim 1, wherein the alarm unit has solar cells and is constructed for operation by an electric current generated by the solar cells.

4. The wireless alarm system of claim 3, wherein the alarm unit has an accumulator to store the electric current generated by the solar cells.

5. The wireless alarm system of claim 1, wherein the alarm unit has a plurality of light sources which emit lights of different colors and are controllable by the radio remote control device individually or in groups.

6. The wireless alarm system of claim 5, wherein the light sources are configured so that different danger stages are indicated in a manner selected from the group consisting of by the different colors of the lights emitted by the light sources, by a combination of the lights of several the light sources, and by both.

7. The wireless alarm system of claim 5, wherein the radio remote control device controls the light sources so as to emit light in a manner selected from the group consisting of emitting a blinking light, emitting a light in a horizontal direction, emitting a light in a vertical direction, and combinations thereof.

8. The wireless alarm system of claim 1, wherein the alarm unit is configured to illuminate a readable text.

9. The wireless alarm system of claim 1, wherein the radio remote control device is configured for carrying on a human body, with the alarm being triggered substantially inconspicuously by a single actuation.

10. The wireless alarm system of claim 1, wherein the radio remote control device and the alarm unit transmit coded signals there between so that the wireless alarm system is formed as a proprietary system.

11. The wireless alarm system of claim 1, wherein the alarm unit is constructed to send a verification message back to the radio remote control device about a correctly received signal.

12. The wireless alarm system of claim 1, wherein the alarm unit is constructed for securement to an inner side of a window.

13. The wireless alarm system of claim 1, wherein the alarm unit secured on an inner side of a window is constructed to radiate only through the window to the outside.
